(19) United States
(12) Patent Application Publication
(10) Pub. No.: US 2026/0125155 A1
(43) Pub. Date: May 7, 2026

(54) AIR SYSTEM FOR CABIN PRESSURIZATION

(71) Applicant: Honeywell International Inc., Charlotte, NC (US)

(72) Inventors: Vinayak M. Nyamagoudar, Bengaluru (IN); Prashant Deshpande, Torrance, CA (US)

(21) Appl. No.: 19/008,474

(22) Filed: Jan. 2, 2025

(30) Foreign Application Priority Data
Nov. 5, 2024 (IN) 202411084641

(51) Int. Cl. B64D 13/04

(52) U.S. Cl. CPC B64D 13/04

(57) ABSTRACT

In some examples, a system includes a compressor configured to provide a compressed air flow to pressurize a compartment of a vehicle, such as an aircraft. The compressor is configured to provide the compressed air flow using an electrical power provided by an electrical distribution system of the vehicle or a mechanical power provided by a turbine assembly of the vehicle. The system is configured to cause the compressor to transition from using the electrical power to using the mechanical power when the electrical power is below a threshold.

This application claims the benefit of Indian Provisional Patent Application No. 202411084641, filed Nov. 5, 2024, and entitled “AIR SYSTEM FOR CABIN PRESSURIZATION,” the entire contents of which is incorporated herein by reference.

### TECHNICAL FIELD

The present disclosure relates to air supply systems, such as pressurized air supply systems on-board an aircraft.

### BACKGROUND

Vehicles, such as aircraft, may include a pressurized air supply system to supply a vehicle with air and provide climate control (e.g., temperature and pressure) within one or more compartments of the vehicle. In the case of an aircraft, the pressurized air supply system may receive an air flow and condition the air flow prior to providing the air flow to the compartment. In examples, the pressurized air system cools the air flow and provides for recirculation among the compartments of the vehicle. In some examples, the pressurized air system may provide pressurization to the aircraft interior for the comfort and/or safety of passengers and crew.

### SUMMARY

In examples, a system comprises a turbine assembly configured to couple to a vehicle body of a vehicle, the turbine assembly including a turbine configured to produce a mechanical power when the turbine receives a ram air flow; a compressor configured to receive an inlet air flow, wherein the compressor is configured to compress the inlet air flow using a compressor power to provide a compressed air flow, wherein the compressor power includes at least one of an electrical power provided by an electrical distribution system of the vehicle or the mechanical power produced by the turbine; and a clutching mechanism having an engaged configuration and a disengaged configuration, wherein the clutching mechanism is configured to limit a delivery of the mechanical power from the turbine assembly to the compressor in the disengaged configuration and increase the delivery of the mechanical power from the turbine assembly to the compressor in the engaged configuration, and wherein the clutching mechanism is configured to transition from the disengaged configuration to the engaged configuration when the electrical power provided by the electrical distribution system decreases below a threshold

In examples, a system comprises a turbine assembly including a turbine, the turbine assembly configured to establish a deployed configuration relative to an aircraft body of an aircraft and establish a stowed configuration relative to the aircraft body, wherein the turbine is configured to receive a ram air flow and produce a mechanical power using the ram air flow when the turbine assembly is in the deployed configuration, and wherein the turbine assembly is configured to limit a receipt of the ram air flow by the turbine when the turbine assembly is in the stowed configuration; a compressor configured to receive an air flow, wherein the compressor is configured to compress the air flow to provide a compressed air flow using a compressor power, wherein the compressor is configured to produce the compressor power using at least one of an electrical power provided by an electrical distribution system of the aircraft or the mechanical power produced by the turbine; and a clutching mechanism having an engaged configuration and a disengaged configuration, wherein the clutching mechanism is configured to limit a delivery of the mechanical power from the turbine to the compressor in the disengaged configuration and increase the delivery of the mechanical power from the turbine to the compressor in the engaged configuration, wherein the clutching mechanism is configured to transition from the disengaged configuration to the engaged configuration when the electrical power provided by the electrical distribution system decreases below a threshold, wherein the turbine assembly is configured to transition from the stowed configuration to the deployed configuration when the electrical power provided by the electrical distribution system decreases below the threshold, and wherein the system is configured to provide the compressed air flow to a compartment supported by the aircraft.

In an example, a technique comprises compressing, by a compressor using electrical power from an electrical distribution system of an aircraft, an inlet air flow, wherein the compressor is configured to compress the inlet air flow using at least one of the electrical power or a mechanical power produced by a turbine assembly; and causing, when the electrical power decreases below a threshold, and by transitioning a clutching mechanism from a disengaged configuration to an engaged configuration, the compressor to compress the inlet air flow using the mechanical power, wherein the clutching mechanism is configured to limit a delivery of the mechanical power from the turbine assembly to the compressor in the disengaged configuration and increase the delivery of the mechanical power from the turbine assembly to the compressor in the engaged configuration.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic illustration of a portion of a vehicle including an air system configured to deliver an air flow to one or more compartments of the vehicle.

FIG. 2 is a schematic illustration of an air system including a compressor configured to receive compressor power from an electrical distribution system of an aircraft or a ram air turbine.

FIG. 3 is a flow diagram illustrating an example method of providing pressurized air to a compartment of a vehicle.

### DETAILED DESCRIPTION

The present disclosure describes a system configured to provide pressurized air to a compartment of a vehicle, such as an aircraft. For example, the system may be configured to provide the pressurized air to one or more of a passenger cabin of an aircraft, a flight deck of the aircraft, a cargo hold of the aircraft, and/or other compartments of the aircraft. In examples, the system is configured to receive an inlet air flow from an environment external to the aircraft and pressurize (e.g., compress) the inlet air flow prior to providing it to the compartment, in order to provide pressurization to the aircraft interior for the comfort and/or safety of passengers and crew.

The system includes a compressor configured to receive the inlet air flow from an environment external to the aircraft and pressurize the inlet air flow. In examples, the compressor is configured to receive the inlet air flow via an air intake, such as a scoop or cowl. In examples, the air intake projects from an outer surface of the aircraft. The air intake is configured to receive the inlet air flow during a flight phase of the aircraft, hence the air stream received may be at a relatively low pressure (e.g., less than about 5 psi (0.34 Bar)). The compressor is configured to receive the inlet air flow (e.g., at the relatively low pressure) and compress the inlet air flow, such that the system may maintain a pressurized air environment in the one or more compartments of the aircraft. Hence, during typical flight operation, the system is configured to receive a flow of the relatively low pressure air surrounding the aircraft and increase the pressure of the air before providing it to the compartment, in order to substantially maintain pressurization of the compartment.

The compressor is configured to compress the inlet air flow to produce a compressed air flow using a compressor power provided to the compressor. The system is configured such that the compressor may receive the compressor power from a plurality of power sources on board the aircraft. The compressor is configured to provide the compressed air flow to a compartment of the aircraft. Hence, the system is configured to safeguard against a loss of compartment pressure (e.g., cabin or flight deck pressure) if a power source providing the compressor power suffers a casualty.

For example, the aircraft may include a first source of compressor power (e.g., a source of electrical power) and a second source of compressor power (e.g., a source of mechanical power). The system may be configured to cause the compressor to transition from receiving the compressor power from the first source (e.g., the electrical power) to receiving the compressor power from the second source (e.g., the mechanical power) if the first source becomes unable to provide the compressor power. For example, when the compressor (e.g., a compressor motor) is receiving electrical power from an electrical distribution system of the aircraft, the system may be configured to transition the compressor to receiving mechanical power in the event the electrical power becomes unavailable. Hence, the system is configured to maintain a provision of compressor power to the compressor to, for example, safeguard against loss of pressure accidents which could otherwise occur.

In examples, the compressor includes a compressing element configured to cause compression of the inlet air flow. The compressor may be configured to cause the compressing element to compress the inlet air flow using the compressor power. In examples, the compressing element is be configured to cause compression of the inlet air flow when the compressing element moves relative to a housing of the compressor (“compressor housing”). The compressor may be configured to cause the relative movement of the compressing element using electrical power or mechanical power. For example, the compressor may include a motor (“compressor motor”) configured to cause the relative movement of the compressing element when the compressor (e.g., the compressor motor) receives electrical power. The compressor may include a input shaft configured to cause the relative movement of the compressing element when the compressor (e.g., the input shaft) receives mechanical power (e.g., receives a torque energy). The system is configured to at least cause the compressor to transition from receiving the electrical power (e.g., by the compressor motor) to receiving the mechanical power (e.g., by the input shaft), such that interruptions of compressor operation are limited upon a loss of the electrical power.

The system includes a turbine assembly including a turbine configured to produce the mechanical power. The turbine assembly may be coupled to (e.g., supported by) a body of the aircraft (“aircraft body”). In examples, the turbine is configured to receive a ram air flow to generate the mechanical energy. For example, the turbine may include a plurality of turbine blades (“turbine blades”) coupled to a shaft (“turbine shaft”). The turbine blades may be configured to cause rotation of the turbine shaft when the ram air flow impacts the turbine blades, such that the turbine blades generate mechanical energy and transfer the mechanical energy to the turbine shaft. The system (e.g., when electrical power to the compressor motor is lost or insufficient) may be configured to transfer the mechanical power generated by the turbine to the compressor, such that compressor may provide the compressed air flow using the mechanical power. Thus the system is configured (e.g., when electrical power to the compressor motor is lost or insufficient) to transfer the mechanical energy produced by the turbine to the compressor, such that the compressor may compress the inlet air flow (e.g., for pressurization of a compartment) using the mechanical energy generated from the ram air flow.

As used herein, a ram air flow may mean a volume of air which has a velocity relative to the turbine assembly (e.g., a turbine blade) and/or the aircraft body. For example, when the aircraft travels in a first direction at a first speed (e.g., a speed-over-ground), the travel of the aircraft may cause a volume of air external to the aircraft to have a velocity relative to the turbine assembly and/or the aircraft body in a second direction substantially opposite the first direction. In examples, when the aircraft travels in a forward direction (e.g., a direction from an aft portion of the aircraft toward a forward portion of the aircraft), the ram air has a relative velocity substantially in an aft direction (e.g., a direction from the forward portion toward the aft portion).

The system includes a clutching mechanism having an disengaged configuration and a engaged configuration. In the disengaged configuration, the clutching mechanism is configured to limit (e.g., to prevent) the delivery of mechanical power from the turbine assembly to the compressor (e.g., the compressor shaft). In the engaged configuration, the clutching mechanism is configured to increase (e.g., to allow) the delivery of mechanical power from the turbine assembly to the compressor (e.g., to the input shaft). The clutching mechanism may be configured to transition from the disengaged configuration to the engaged configuration when electrical power provided to the compressor (e.g., the compressor motor) fails below a threshold. The threshold may be, for example, a level of electrical power (e.g., as indicated by a voltage) too low for operation of the compressor motor, a complete loss of electrical power provided by the electrical distribution system, or some other threshold.

Hence, the system includes a compressor is configured to produce a compressed air flow for a compartment using either an electrical power from an electrical distribution system of an aircraft or a mechanical power from an turbine assembly of the aircraft. The system is configured to transition the compressor at least from using the electrical power to compress the inlet air flow to using the mechanical power to compress the inlet air flow (e.g., using the clutching mechanism). The clutching mechanism may be configured to substantially shift the compressor from the electrical power to the mechanical power when the electrical power provided to the compressor motor fails below a threshold. Hence, the system is configured to safeguard against a loss of compartment pressure (e.g., cabin or flight deck pressure) if an electrical system of the aircraft becomes unable to provide the electrical power.

While an aircraft is primarily referred to herein, the cooling devices, systems, and methods described herein can be used with other vehicles, including marine vehicles and/or land vehicles.

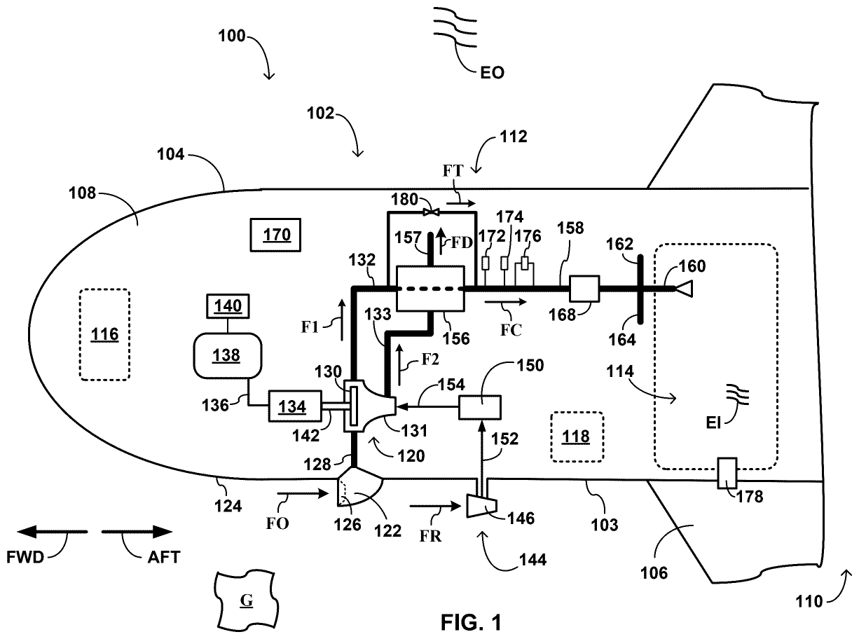

FIG. 1 schematically illustrates an example system 100 configured to provide a compressed air flow FC to one or more compartments of a vehicle 102. In examples, vehicle 102 (e.g., an aircraft) includes a fuselage 104 and wing 106 coupled (e.g., affixed) to fuselage 104. In examples, vehicle 102 includes a body 103 (“vehicle body 103”) defining a forward portion 108 and an aft portion 110. In examples, vehicle 102 is configured to travel (e.g., during flight operations) in at least a forward direction FWD (e.g., a direction from aft portion 110 towards forward portion 108) relative to ground G (e.g., earth's surface). In examples, vehicle 102 is configured to travel (e.g., during flight operations) through an external atmosphere EO substantially external to and/or surrounding vehicle 102. Vehicle 102 includes one or more compartments 112 (“compartments 112”), such as cabin 114, flight deck 116, cargo hold 118, and/or other compartments of vehicle 102 (e.g., one or more galleys, lavatories, and/or other compartments). In examples, compartments 112 are supported by and/or housed within fuselage 104.

System 100 is configured to provide compressed air flow FC to one or more of compartments 112. For example, when vehicle 102 is an aircraft, system 100 may be configured to provide at least some portion of compressed air flow FC to cabin 114. System 100 may provide compressed air flow FC to cabin 114 to substantially maintain an internal atmosphere EI of cabin 114 at a pressure greater than or equal to external atmosphere EO. Although discussed largely with reference to cabin 114 in the examples below, system 100 may be configured to provide at least portions of compressed air flow FC to other of compartments 112 in substantially the same manner as system 100 provides the portion of compressed air flow FC to cabin 114.

System 100 is configured to receive an inlet air flow FO from external environment EO and pressurize (e.g., compress) inlet air flow FO to provide compressed air flow FC to cabin 114 (and/or other compartments of vehicle 102). System 100 includes a compressor 120 configured to receive inlet air flow FO from external environment EO and pressurize inlet air flow FO. In examples, compressor 120 is configured to receive inlet air flow FO via an air intake 122, such as a scoop or cowl. In some examples, air intake 122 substantially projects from an outer surface 124 (e.g., an aircraft skin) of vehicle 102, although this is not required. Outer surface 124 may be a portion of vehicle body 103.

Air intake 122 may be configured to receive intake air flow FO at least as vehicle 102 travels in forward direction FWD. In examples, air intake 122 defines an opening 126 (“intake opening 126”) configured to receive intake air flow FI. In some examples, air intake 122 is configured such that intake opening 126 substantially faces toward forward direction FWD. Air intake 122 may be configured in any manner sufficient to receive inlet air flow FO (e.g., via intake opening 126). Further, although represented in FIG. 1 as projecting substantially from a side of vehicle 102, air intake 122 may be supported by and/or project from any portion of vehicle 102, and/or may be an opening defined by outer surface 124 which is substantially flush with outer surface 124.

In examples, compressor 120 includes a housing 131 (“compressor housing 131”), a compressing element 130, and a motor 134 (“compressor motor 134”). Compressor 120 is configured to compress (e.g., increase a pressure of) inlet air flow FI. Compressor 120 may be configured to receive inlet air flow FO from air intake 122 (e.g., via a conduit 128). Compressor 120 may be configured to compress at least some portion of inlet air flow FO using compressing element 130 (e.g., an impellor, a plurality of compressor blades, and/or another compressing element) to increase a pressure of inlet air flow FO (e.g., to increase the pressure above a pressure of external environment EO). In examples, compressor 120 is configured to compress at least some portion of inlet air flow FO and issue a first flow F1 having a pressure greater than inlet air flow FO (e.g., greater than a pressure of external environment EO). In some examples, compressor 120 is configured to discharge first flow F1 to a conduit 132. Compressor 120 may be any type of compressor configured to receive inlet air flow FO and issue first flow F1 at a higher pressure than inlet air flow FO. In examples, compressing element 130 is configured to move relative to a compressor housing 131 to cause compressor 120 to compress inlet air flow FO and provide first flow F1.

Compressor 120 is configured to compress at least a portion of inlet air flow FO and provide first flow F1 using a compressor power provided to compressor 120. Compressor 120 (e.g., compressor motor 134) is configured to receive the compressor power as an electrical power (e.g., a power comprising an electrical voltage and/or electrical current) and also configured to receive the compressor power as a mechanical power (e.g., via a mechanical component providing a torque and/or other mechanical force).

For example, compressor motor 134 may be configured to receive electrical power from an electrical distribution system 138 of vehicle 102. In examples, compressor motor 134 is configured to receive the electrical power via one or more electrical cables 136 (“electrical cables 136”). Compressor motor 134 may be configured to cause compressor 120 to compress inlet air flow FO and provide first flow F1 when compressor motor 134 receives the electrical power. For example, compressor motor 134 may be configured to cause compressing element 130 to move relative to compressor housing 131 using a shaft 142 of compressor 120 (“compressor shaft 142”) when compressor motor 134 receives the electrical power. Hence, compressor 120 is configured to compress inlet air flow FO to provide first flow F1 when compressor 120 receives the compressor power as an electrical power (e.g., when compressor motor 134 receives the electrical power from electrical distribution system 138).

Compressor 120 may be any type of compressor including any type of compressing element 130 configured to receive at least some portion of inlet air flow FO and compress the portion to discharge first flow F1. For example, compressing element 130 may include one or more airfoils configured to move relative to compressor housing 131 (e.g., compressor 120 may be an axial compressor). In examples, compressing element 130 includes an impellor configured to move relative to compressor housing 131 (e.g., compressor 120 may be a centrifugal compressor). Compressing element 130 may include one or more pistons configured to move relative to compressor housing 131 (e.g., compressor 120 may be a reciprocating and/or positive displacement compressor). Compressing element 130 may include one or more spiral rotors configured to move relative to compressor housing 131 (e.g., compressor 120 may be a rotary screw compressor). Compressing element 130 may include one or more vanes configured to move relative to compressor housing 131 (e.g., compressor 120 may be a rotary vane compressor). Compressor 120 may be another type of compressor including another type of compressing element 130 in other examples.

In examples, electrical distribution system 138 is configured to receive the electrical power from a power source 140 supported by vehicle 102. Power source 140 may be a turbine generator, a fuel cell, a battery, or some other power source configured to supply electrical power to electrical distribution system 138. Instead of or in addition to power source 140, in some examples, electrical distribution system 138 and/or compressor motor 134 may be configured to receive electrical power provided by a ground based power source and provided to vehicle 102.

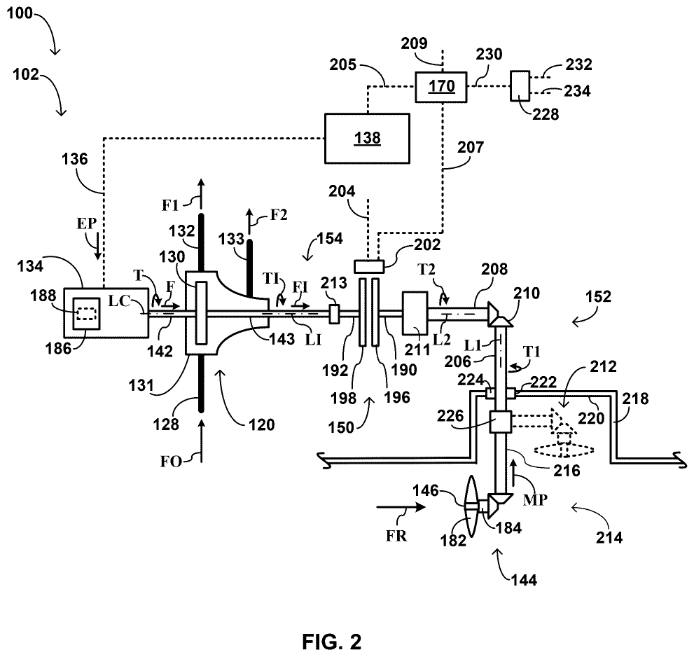

Compressor 120 is further configured to compress inlet air flow FO and provide first flow F1 when the compressor power received by compressor 120 is a mechanical power. In examples, system 100 includes a turbine assembly 144 including a turbine 146 configured to produce the mechanical power. Turbine assembly 144 may be coupled to (e.g., supported by) vehicle body 103. In examples, turbine 146 is configured to receive a ram air flow FR to generate the mechanical energy. For example, turbine 146 may include a plurality of blades (e.g., turbine blades 182 (FIG. 2)) coupled to a turbine shaft (e.g., turbine shaft 184 (FIG. 2)). The turbine blades may be configured to cause rotation of the turbine shaft when ram air flow FR impacts the turbine blades, such that the turbine blades generate mechanical energy and transfer the mechanical energy to the turbine shaft.

System 100 (e.g., when electrical power to compressor motor 134 is lost or insufficient) is configured to transfer the mechanical power generated by turbine 146 to compressor 120, such that compressor 120 may provide compressed flow FC (e.g., to cabin 114) using the mechanical power. Hence, in a typical operation, system 100 may provide compressed flow FC to cabin 114 using compressor motor 134 as compressor motor 134 receives electrical power from electrical distribution system 138. If the electrical power to compressor motor 134 is lost or insufficient, system 100 may transition compressor 120 to receive mechanical power from turbine assembly 144, such that compressor 120 continues to provide compressed air flow FC to cabin 114 (and/or other of compartments 112).

In examples, system 100 includes a clutching mechanism 150 configured to transfer mechanical power generated by turbine assembly 144 (e.g., turbine 146) to compressor 120. For example, clutching mechanism 150 may be configured to receive mechanical power from turbine 146 via an input pathway 152 and provide at least some portion of the mechanical power to compressor 120 via an output pathway 154. In examples, input pathway 152 includes one or more components such as shafts, linkages, gears, and/or other components configured to transfer mechanical power (e.g., a torque energy) from turbine 146 to clutching mechanism 150. Output pathway 154 may include one or more components such as shafts, linkages, gears, and/or other components configured to transfer mechanical power (e.g., a torque energy) from clutching mechanism 150 to compressor 120. Input pathway 152 and/or output pathway 154 may be configured to transfer mechanical power in any manner. In some examples, input pathway 152 and/or output pathway 154 may include one or more components configured to transfer mechanical energy between a first component and a second component using an electromagnetic or magnetic field extending between the first component and the second component.

Clutching mechanism 150 may be configured to transition between a disengaged configuration and an engaged configuration to control the provision of mechanical power to compressor 120. For example, in the disengaged configuration, clutching mechanism 150 is configured to limit (e.g., to prevent) the delivery of mechanical power from input pathway 152 to output pathway 154, such that the delivery of mechanical power to compressor 120 is limited. In the engaged configuration, clutching mechanism 150 may be configured to increase (e.g., to allow) the delivery of mechanical power from input pathway 152 to output pathway 154, such that the mechanical power delivered to compressor 120 is increased.

In examples, system 100 (e.g., clutching mechanism 150) is configured to cause clutching mechanism 150 to transition from the disengaged configuration (limiting the transfer of mechanical power) to the engaged configuration (increasing the transfer of mechanical power) when electrical power provided to compressor motor 134 and/or by electrical distribution system 138 falls below a threshold. For example, clutching mechanism 150 may have one or more components (e.g., transfer system 202 (FIG. 2)) configured to substantially maintain clutching mechanism 150 in the disengaged configuration when clutching mechanism 150 receives electrical power from electrical distribution system 138 (e.g., when the one or more components receive a voltage and/or current). The one or more components may be configured to cause clutching mechanism 150 to transition to the engaged configuration when the electrical power falls below the threshold. Hence, system 100 may be configured to transition clutching mechanism 150 from the disengaged configuration to the engaged configuration when electrical power from electrical distribution system 138 falls below the threshold, such that compressor 120 transitions from compressing inlet air flow FO using electrical power (e.g., received by compressor motor 134) to compressing inlet air flow FO using mechanical power (e.g., provided via clutching mechanism 150).

In examples, system 100 includes a heat exchanger 156 configured to exchange heat with first flow F1 to, for example, reduce a temperature of flow F1. Heat exchanger 156 may be configured to receive flow F1 (e.g., from conduit 132) and receive a cooling flow F2 (e.g., from a conduit 133). Heat exchanger 156 may be configured to cause a heat exchange from flow F1 to cooling flow F2. In examples, heat exchanger 156 is configured to issue compressed flow FC, where compressed flow FC comprises first flow F1 less the heat transferred to cooling flow F2. Heat exchanger 156 may be configured to issue a flow FD (e.g., via a conduit 157), where flow FD comprises cooling flow F2 plus the heat transferred from first flow F1. Conduit 157 may be configured to discharge flow FD into external environment EO (e.g., configured to discharge flow FD overboard) or configured to discharge flow FD to another system of vehicle 102.

In some examples, cooling flow F2 is an air flow, such as another portion of inlet air flow FO. For example, system 100 may be configured to provide a first portion of inlet air flow FO to compressor 120 (e.g., via conduit 128) and provide a second portion of inlet air flow FO to heat exchanger 156 (e.g., via conduit 133). Compressor 120 may be configured to compress (e.g., pressurize) the first portion to produce first flow F1. Compressor 120 may be configured such that first flow F1 (e.g., the compressed first portion) has a greater temperature than inlet flow FO due to, for example, a heat of compression of the first portion. Heat exchanger 156 may be configured to receive the second portion and use the second portion as cooling flow F2, such that heat exchanger 156 causes a heat exchange from first flow F1 to cooling flow F2. Heat exchanger 156 may be configured to issue the thus cooled first flow F1 as compressed air flow FC.

System 100 may be configured to provide cooling flow F2 to heat exchanger 156 in any manner. In some examples, compressor 120 (e.g., compressor housing 131) is configured to receive inlet air flow FO and issue first flow F1 and cooling flow F2. For example, cooling flow F2 may be a portion of inlet air flow FO received by compressor housing 131 and which substantially bypasses at least some portion of compressing element 130. Compressor 120 (e.g., compressor housing 131) may be configured such that first flow F1 (e.g., as a result of compression) has a higher temperature and a higher pressure than cooling flow F2. Heat exchanger 156 may be configured to receive first flow F1 and cooling flow F2 from the second portion and use the second portion as cooling flow F2, such that heat exchanger 156 causes a heat exchange from first flow F1 to cooling flow F2. In other examples, system 100 may be configured to provide cooling flow F2 in other ways. For example, system 100 may include a second air intake (not shown) in addition to air intake 122, with the second air intake configured to receive cooling flow F2. In some examples, system 100 may be configured such that conduit 133 substantially bypasses compressor housing 131 (e.g., branches from conduit 128), rather than receiving cooling flow F2 from compressor housing 131.

In examples, heat exchanger 156 is configured to issue compressed air flow FC (or at least some portion thereof) to a supply conduit 158. Supply conduit 158 may be configured to provide (e.g., deliver) compressed air flow FC to one or more of compartments 112. For example, supply conduit 158 may include a first section 160 (e.g., a first branch) configured to deliver some portion of compressed flow FC to cabin 114. Supply conduit 158 may include a second section 162 (e.g., a second branch) configured to deliver another portion of compressed flow FC to flight deck 116. Supply conduit 158 may include a third section 164 (e.g., a third branch) configured to deliver a different portion of compressed flow FC to cargo hold 118. Supply conduit 158 may include any number of sections configured to supply at least a portion of compressed air flow FC to one or more other compartments of vehicle 102. Supply conduit 158 may include a variety of components for transporting and dispersing the supply air into compartments 112 including, but not limited to supply ducting, supply air vents, gaspers, and the like. The supply ducting, supply air vents, gaspers, and the like may be distributed throughout compartments 112.

System 100 may be configured to substantially recirculate air among compartments 112 of vehicle 102. For example, system 100 may include a return air system (not shown) configured to receive a return air from one or more of compartments 112. System 100 may include one or more mixing manifolds configured to mix compressed flow FC and the return air to, for example, assist in substantially establishing and/or maintaining a relative homogeneity among the atmospheres in compartments 112. In some examples, system 100 includes additional components configured to condition the air flow used to produce compressed air flow FC, such as component 168. Component 168 may be, for example, a component configured to reduce moisture in (e.g., dehumidify) the air flow and/or otherwise condition the air flow used to produce compressed air flow FC.

System 100 may include one or more sensors configured to sense one or more parameters (e.g., temperature and/or pressure) of compressed air flow FC, internal environment EI within cabin 114, and/or an internal environment within another of compartments 112. For example, system 100 may include a sensor 172 configured to sense a temperature associated with compressed flow FC. System 100 may include a sensor 176 configured to sense a pressure associated with compressed flow FC. System 100 may include a sensor 174 configured to sense a differential pressure associated with compressed flow FC.

In some examples, system 100 includes a control system 170 configured to control a pressure and/or other parameters of internal environment EI within cabin 114 and/or other of compartments 112. In examples, control system 170 is configured to control one or more portions of system 100 based on parameters sensed by sensor 172, sensor 174, sensor 176, and/or other sensors within system 100. In examples, control system 170 is configured to control a pressure of one or more of compartments 112 using one or more outflow valves such as outflow valve 178. Outflow valve 178 may be configured to discharge air from one or more of compartments 112 (e.g., cabin 114) to an environment surrounding vehicle 102 (e.g., external environment EO) to control the pressure in compartments 112. In some examples, outflow valve 178 is a thrust recovery valve. System 100 may include any number of outflow valves such as outflow valve 178. Any of the outflow valves may be configured to discharge air from one or more of compartments 112 to an environment surrounding vehicle 102.

In examples, system 100 is configured to control a temperature of compressed air flow FC. For example, system 100 may be configured to provide a trim air FT to control the temperature of compressed flow FC. In some examples, trim air FT may be a portion of first flow F1 and/or cooling flow F2. In examples, system 100 is configured such that trim air FT substantially bypasses at least some portion of heat exchanger 156. Hence, trim air FT may have a higher temperature than compressed air flow FC provided by heat exchanger 156. System 100 (e.g., control system 170) may be configured to substantially control the temperature of compressed air flow FC by causing the mixing of trim air FT with compressed air flow FC (e.g., prior to providing compressed air flow FC to compartments 112). In examples, system 100 includes one or more trim valves such as trim valve 180 configured to control a flow of trim air FT. A position of trim valve 180 may be controlled (e.g., via control system 170) by a thermostat and/or members of a flight crew to control a temperature of compressed flow FC. In some examples, system 100 includes a plurality of trim valves such as trim valve 180 to enable separate temperature control of some of or each of compartments 112.

Hence, in some examples, system 100 is configured to receive inlet air flow FO during a flight phase of vehicle 102. During the flight phase, inlet air flow FO may be at a relatively low pressure (e.g., less than about 5 psi (0.34 Bar)). Compressor 120 configured to receive inlet air flow FO (e.g., at the relatively low pressure) and compress inlet air flow FO, such that system 100 may maintain a pressurized air environment in one or more compartments of compartments 112. Compressor 120 may be configured to compress inlet air flow FO using electrical power provided by electrical distribution system 138 or mechanical power provided by turbine assembly 144. System 100 includes a clutching mechanism 150 configured to transition compressor 120 from receiving the electrical power to receiving the mechanical power in the event the electrical power falls below a threshold, such that compressor 120 continues to provide compressed flow FC should electrical distribution system 138 fail to provide the electrical power.

FIG. 2 schematically illustrates system 100 including electrical distribution system 138 and turbine assembly 144 configured to provide a compressor power to compressor 120. As depicted in FIG. 2, a first input shaft 206 defines a portion of input pathway 152 of FIG. 1 and a compressor input shaft 143 defines a portion of output pathway 154 of FIG. 1, although this is not required. Turbine 146 includes a plurality of blades 182 (“turbine blades 182”) configured to cause a rotational torque on a shaft 184 of turbine 146 (“turbine shaft 184”) (e.g., when turbine blades 182 are impacted by ram air flow FR). System 100 is configured to transition (e.g., using clutching mechanism 150) compressor 120 from receiving electrical power (e.g., electrical power EP) from electrical distribution system 138 (e.g., via electrical cables 136) to receiving mechanical power (e.g., mechanical power MP) produced by turbine 146 (e.g., when electrical power EP provided by electrical distribution system 138 falls below a threshold).

In examples, system 100 is configured to cause compressor 120 to compress inlet flow FO using electrical power EP (e.g., by substantially maintaining clutching mechanism 150 in the disengaged configuration) when the electrical power EP is greater than or equal to the threshold. System 100 may be configured to cause compressor 120 to compress inlet flow FO using mechanical power MP (e.g., by substantially maintaining clutching mechanism 150 in the engaged configuration) when the electrical power EP is less than the threshold. System 100 may be configured to cause compressor 120 to transition from compressing inlet flow FO using electrical power EP to compressing inlet flow FO using mechanical power MP (e.g., by transitioning clutching mechanism 150 from the disengaged configuration to the engaged configuration) when the electrical power EP falls below the threshold. In some examples, system 100 may be configured to cause compressor 120 to transition from compressing inlet flow FO using mechanical power MP to compressing inlet flow FO using electrical power EP (e.g., by transitioning clutching mechanism 150 from the engaged configuration to the disengaged configuration) when the electrical power EP increases to above the threshold.

For example, in a typical operation, compressor motor 134 may receive electrical power EP and transfer at least one of a rotary torque T or a substantially linear force F to compressor 120 (e.g., compressing element 130) using electrical power EP, such that compressor 120 provides first flow F1 and/or cooling flow F2. In examples, compressor motor 134 is configured to transfer rotary torque T and/or linear force F using compressor shaft 142. For example, compressor motor 134 may be configured to transfer rotary torque T substantially around an axis LC defined by compressor 120 (“compressor shaft axis LC”). Compressor motor 134 may be configured to transfer linear force F in a direction substantially parallel to compressor shaft axis LC. Compressor 120 may be configured to transfer rotary torque T and/or linear force F from compressor shaft 142 to compressing element 130 to cause movement of compressing element 130 relative to compressor housing 131. Compressing element 130 may be configured to compress at least some portion of inlet air flow FO (e.g., to cause compressor 120 to provide first flow F1 and/or cooling flow F2) when compressing element 130 moves relative to compressor housing 131.

In examples, compressor motor 134 is configured to transfer rotary torque T and/or linear force F to compressor 120 when compressor motor 134 receives electrical power EP (e.g., from electrical distribution system 138) above a threshold. The threshold may be, for example, a minimum voltage, a minimum current, and/or a minimum electrical power received by compressor motor 134. The minimum voltage, a minimum current, and/or a minimum electrical power may be substantially zero in some examples, or may be some other non-zero value in other examples.

In some examples, compressor motor 134 includes a controller 186 (“motor controller 186”) configured to receive the electrical power and cause compressor motor 134 to transfer rotary torque T and/or linear force F to compressor 120. Motor controller 186 may be configured to cause compressor motor 134 to transfer rotary torque T and/or linear force F when motor controller 186 receives electrical power (e.g., from electrical distribution system 138) above the threshold. Motor controller 186 may be configured to cause compressor motor 134 to cease transferring rotary torque T and/or linear force F when the electrical power received by motor controller 186 falls below the threshold. In some examples, motor controller 186 includes control circuitry 188 (“motor control circuitry 188”) configured to cause motor controller 186 to one of cause compressor motor 134 to transfer rotary torque T and/or linear force F, or cause compressor motor 134 to cease transferring rotary torque T and/or linear force F (e.g., based on electrical power received by motor controller 186). In some examples, motor control circuitry 188 may be configured to cause compressor motor 134 to one of transfer rotary torque T and/or linear force F or cease transferring rotary torque T and/or linear force F based on a signal (e.g., a fault signal) issued by some portion of electrical distribution system 138, control system 170, and/or other control circuitry of vehicle 102.

Compressor 120 is configured to receive mechanical power MP from output pathway 154 at least when the electrical power EP received by compressor motor 134 is below (e.g., falls below) the threshold. Output pathway 154 may be configured to transfer the mechanical power MP to compressor 120 as a rotary input torque TI and/or a linear input force FI. In examples, compressor 120 includes a input shaft 143 (“compressor input shaft 143”) configured to receive mechanical power MP from output pathway 154. For example, compressor input shaft 143 may be configured to receive rotary input torque T1 substantially around an axis LI defined by compressor input shaft 143 (“input shaft axis LI”). Compressor input shaft 143 may be configured to receive linear input force FI in a direction substantially parallel to input shaft axis LI. Compressor 120 may be configured to transfer rotary input torque TI and/or linear input force FI from compressor input shaft 143 to compressing element 130 to cause movement of compressing element 130 relative to compressor housing 131 (e.g., to cause to cause compressor 120 to provide first flow F1 and/or cooling flow F2).

In some examples, input shaft axis LI may be substantially parallel to and/or substantially coincident with compressor shaft axis LC. In some examples, input shaft axis LI and compressor shaft axis LC are portions of a substantially unitary shaft extending substantially through compressing element 130 (e.g., through an aperture defined by compressing element 130) and extending to compressor motor 134.

Clutching mechanism 150 is configured to transfer mechanical power MP from input pathway 152 to output pathway 154, such that compressor 120 may receive mechanical power MP produced by turbine assembly 144. In examples, clutching mechanism 150 is configured to transfer the mechanical power MP when the electrical power EP provided by electrical distribution system 138 (e.g., to compressor motor 134) is less than the threshold, such that compressor 120 transitions from compressing inlet flow FO using electrical power EP (e.g., from electrical distribution system 138) to compressing inlet flow FO using a mechanical power MP (e.g., from turbine assembly 144). In examples, clutching mechanism 150 is configured to transition from the disengaged configuration to the engaged configuration when clutching mechanism 150 causes compressor 120 to transition from using electrical power EP to using mechanical power MP.

Clutching mechanism 150 may be configured such that, in the disengaged configuration, clutching mechanism 150 is configured to limit (e.g., to prevent) the transfer of mechanical power MP from turbine assembly 144 to compressor 120. Clutching mechanism 150 may be configured such that, in the engaged configuration, clutching mechanism 150 is configured to increase (e.g., to allow) the transfer of mechanical power MP from turbine assembly 144 to compressor 120. In examples, clutching mechanism 150 is configured to limit (e.g., to prevent) the delivery of mechanical power MP from input pathway 152 to output pathway 154 in the disengaged configuration. Clutching mechanism 150 may be configured to increase (e.g., to allow) the delivery of mechanical power MP from input pathway 152 to output pathway 154 in the engaged configuration.

Hence, compressor 120 is configured to produce compressed air flow FC using either electrical power EP (e.g., from electrical distribution system 148) or mechanical power MP (e.g., from turbine assembly 144). Clutching mechanism 150 may be configured to transition compressor 120 from compressing inlet flow FO using electrical power EP to compressing inlet flow FO using mechanical power MP. In examples, clutching mechanism 150 is configured to substantially shift from the disengaged configuration to the engaged configuration when electrical power EP falls below a threshold, such that system 100 substantially safeguards against a loss of compartment pressure (e.g., in internal environment EI) if the electrical distribution system 148 provides electrical power EP below the threshold.

In examples, clutching mechanism 150 includes a input shaft 190 (“clutching input shaft 190”) and an output shaft 192 (“clutching output shaft 192”). Clutching mechanism 150 may be configured to limit (e.g., to prevent) the transfer of mechanical power MP from clutching input shaft 190 to clutching output shaft 192 in the disengaged configuration, and/or be configured to increase (e.g., to allow) the transfer of mechanical power MP from clutching input shaft 190 to clutching output shaft 192 in the engaged configuration.

In some examples, clutching input shaft 190 is coupled to (e.g., mechanically coupled to) input pathway 152. Clutching input shaft 190 may be configured to receive mechanical power MP from input pathway 152 at least when clutching mechanism 150 is in the engaged configuration. In some examples, clutching input shaft 190 is configured to receive mechanical power MP from input pathway 152 when clutching mechanism 150 is in the disengaged configuration. Clutching output shaft 192 may be coupled to (e.g., mechanically coupled to) output pathway 154. Clutching output shaft 192 may be configured to provide (e.g., to transfer) mechanical power MP to output pathway 154 at least when clutching mechanism 150 is in the engaged configuration. increases the transfer of mechanical power MP from clutching input shaft 190 to clutching output shaft 192.

In examples, clutching mechanism 150 includes an input component 196 (“input clutching component 196”) and an output component 198 (“output clutching component 198”). Input clutching component 196 may be configured to receive mechanical power MP from input pathway 152. Input clutching component 196 may be configured to transfer mechanical power MP received from input pathway 152 (e.g., received via clutching input shaft 190) to output clutching component 198 when clutching mechanism 150 is in the engaged configured. Output clutching component 198 may be configured to transfer the mechanical power MP (e.g., via clutching output shaft 192) to compressor input shaft 143. Input clutching component 196 may be configured to limit (e.g., substantially prevent) the transfer of mechanical power MP to output clutching component 198 (e.g., even as input clutching component 196 receives mechanical power MP) when clutching mechanism 150 is in the disengaged configuration.

In some examples, input clutching component 196 is configured to contact output clutching component 198 when input clutching component 196 transfers mechanical power MP to output clutching component 198 (e.g., when clutching mechanism 150 is in the engaged configuration). Input clutching component 196 may be configured to displace relative to output clutching component 198 when input clutching component 196 limits the transfer of mechanical power MP to output clutching component 198 (e.g., when clutching mechanism 150 is in the disengaged configuration). For example, clutching mechanism 150 may be configured such that one of input clutching component 196 or output clutching component 198 moves away from the other of input clutching component 196 or output clutching component 198 (e.g., to break contact) when clutching mechanism 150 transitions from the engagement configuration to the disengagement configuration. Clutching mechanism 150 may be configured such that one of input clutching component 196 or output clutching component 198 moves toward the other of input clutching component 196 or output clutching component 198 (e.g., to establish contact) when clutching mechanism 150 transitions from the disengagement configuration to the engagement configuration.

Clutch assembly 150 may include any type of clutching mechanism configured to transfer mechanical power MP from input clutching component 196 to output clutching component 198. For example, clutch assembly 150 may include a plate clutch, a centrifugal clutch, a cone clutch, a dog clutch, a belt clutch, or some other type of clutching mechanism. In some examples, clutch assembly 150 includes an electromagnetic clutch. The electromagnetic clutch may be configured to transfer mechanical power MP from input clutching component 196 to output clutching component 198 using an electromagnetic field between input clutching component 196 to output clutching component 198. For example, clutching mechanism 150 may be configured such that one of input clutching component 196 or output clutching component 198 comprises a rotor and the other of input clutching component 196 or output clutching component 198 comprises an armature. In examples, clutch assembly 150 is configured such that the rotor receives electrical power produced by electrical distribution system 138.

Clutching mechanism 150 may be configured to substantially maintain the disengaged configuration when electrical power EP (e.g., provided to compressor motor 134) is greater than or equal to the threshold. Clutching mechanism 150 may be configured to transition from the disengaged configuration to the engaged configuration when electrical power EP decreases below the threshold. In some examples, clutching mechanism 150 is configured to transition from the engaged configuration to the disengaged configuration when electrical power EP increases from a level below the threshold to level equal to or greater than the threshold. In some examples, clutch assembly 150 includes an transfer system 202 configured to cause clutching mechanism 150 to substantially maintain the disengaged configuration, transition from the disengagement configuration to the engagement configuration, and/or transition from the engagement configuration to the disengagement configuration.

Transfer system 202 may be configured to cause clutching mechanism 150 to substantially maintain the disengaged configuration, transition from the disengagement configuration to the engagement configuration, substantially maintain the engagement configuration, and/or transition from the engagement configuration to the disengagement configuration. In examples, transfer system 202 is configured to cause clutching mechanism 150 to substantially maintain the disengaged configuration when electrical power EP is greater than or equal to the threshold, substantially maintain the engagement configuration when electrical power EP is below the threshold, and/or transition from the disengagement configuration to the engagement configuration when the electrical power EP decreases from a level greater than or equal to the threshold to a level less than the threshold. In some examples, transfer system 202 is configured to cause clutching mechanism 150 to transition from the engagement configuration to the disengagement configuration when the electrical power EP increases from the level less than the threshold to the level equal to or greater than threshold.

In examples, transfer system 202 is configured to sense electrical power EP provided by electrical distribution system 138 via one or more cables 204 (“cables 204”). Transfer system 202 may be configured to establish a first state (e.g., an energized state) when electrical distribution system 138 senses electrical power EP is greater than or equal to the threshold, and establish a second state (e.g., a deenergized state) when electrical power EP is below the threshold. Transfer system 202 may be configured to cause clutching mechanism 150 to substantially maintain one of the engaged configuration or the disengaged configuration in the first state, cause clutching mechanism 150 to substantially maintain the other of the engaged configuration or the disengaged configuration in the second state, and cause clutching mechanism 150 to transition between the engaged configuration and the disengaged configuration when transfer system 202 transitions between the first state and the second state.

For example, transfer system 202 may include a pneumatic and/or hydraulic system configured to cause clutching mechanism 150 to at least one of substantially maintain the disengaged configuration, substantially maintain the engaged configuration, and/or transition between the disengagement configuration and the engagement configuration using a fluid pressure in the pneumatic and/or hydraulic system. Transfer system 202 may be configured to alter the fluid pressure based on electrical power EP provided by electrical distribution system 138 (e.g., to compressor motor 134). Transfer system 202 may include one or components (e.g., one or more valves) configured to alter their position (e.g., to open or close) when transfer system 202 transitions between the first state and the second state. Transfer system 202 may be configured such that altering the position of the component alters the fluid pressure in the pneumatic and/or hydraulic system, and causes clutching mechanism 150 to transition between the disengagement configuration and the engagement configuration. In some examples, (e.g., when clutching mechanism 150 includes an electromagnetic clutch), transfer system 202 may be configured to alter an electromagnetic field between input clutching component 196 to output clutching component 198 based on electrical power EP provided by electrical distribution system 138 (e.g., to compressor motor 134).

Transfer system 202 may include one or electrical and or electronic components (e.g., one or more switches or relays) configured to provide and/or interrupt a delivery of electrical power to transfer system 202 based on electrical power EP provided by electrical distribution system 138. The electrical and/or electronic components may be configured to alter their position (e.g., transition between an open position or a closed position) when transfer system 202 transitions between the first state and the second state. Transfer system 202 may be configured such that altering the position of the electrical and/or electronic components causes clutching mechanism 150 to transition between the disengagement configuration and the engagement configuration.

In some examples, control system 170 is configured to cause transfer system 202 to maintain the first state, maintain the second state, and/or transition between the first state and the second state. For example, control system 170 may be configured to sense electrical power EP provided by electrical distribution system 148 (e.g., via one or more cables 205 (“cables 205”)). Control system 170 may be configured to detect when electrical power EP is greater than or equal to the threshold or less than the threshold using cables 205. Control system 170 may be configured to cause transfer system 202 to establish the first state when control system 170 senses (e.g., using cables 205) that electrical power EP is greater than or equal to the threshold. Control system 170 may be configured to cause transfer system 202 to establish the second state when control system 170 senses (e.g., using cables 205) that electrical power EP is below the threshold. In examples, control system 170 is configured to send a signal (e.g., via a communication link 207) to transfer system 202 to cause transfer system 202 to maintain the first state, maintain the second state, and/or transition between the first state and the second state. Transfer system 202 may include transfer system control circuitry (not shown) configured to cause transfer system 202 to maintain the first state, maintain the second state, and/or transition between the first state and the second state based on the signal (or lack thereof).

In examples, input pathway 152 comprises one or more mechanical components configured to transfer mechanical power MP from turbine assembly 144 (e.g., turbine 146) to clutching mechanism 150. For examples, input pathway 152 may include a first shaft 206 (“first input shaft 206”) configured to provide at least some portion of input pathway 152. In examples, first input shaft 206 is configured to receive at least some portion of the mechanical power MP produced by turbine 146 and transfer the portion of the mechanical power MP to another portion of input pathway 152 and/or clutching mechanism 150. In some examples, first input shaft 206 is comprises at least a portion of a mechanical pathway configured to transfer the mechanical power MP to a second shaft 208 of input pathway 152 (“second input shaft 208”).

In examples, input pathway 152 is configured to receive mechanical power PM from turbine assembly 144 as an input rotational power T1 acting around a first axis L1 and transfer mechanical power PM to clutching mechanism 150 as an output rotational power T2 acting around a second axis L2 different from first axis L1. In examples, second axis L2 is angularly displaced from first axis L1. In some examples, input pathway 152 includes a gear assembly 210 configured to receive input rotational power T1 acting around first axis L1 and provide output rotational power T2 acting around second axis L2. Gear assembly 210 may include, for example, one or more bevel gears or other types of gears configured to receive input rotational power T1 acting around first axis L1 and provide output rotational power T2 acting around second axis L2. In some examples, first input shaft 206 defines first axis L1. Second input shaft 208 may define second axis L2. In examples, input pathway 152 is configured to transfer mechanical power MP from turbine assembly 144 to clutching mechanism 150 as at least one of input rotational power T1 or output rotational power T2.

Clutching mechanism 150 (e.g., input clutching component 196) is configured to receive at least one of input rotational power T1 or output rotational power T2 from input pathway 152. Clutching mechanism 150 may be configured to transfer the at least one of input rotational power T1 or output rotational power T2 from input clutching component 196 to output clutching component 198 (e.g., when clutching mechanism 150 is in the engaged configuration). Output clutching component 198 may be configured to transfer the at least one of input rotational power T1 or output rotational power T2 to compressor input shaft 143, such that the at least one of input rotational power T1 or output rotational power T2 provides the mechanical power MP to compressor 120.

In some examples, input pathway 152 includes a speed changer 211 configured to convert at least one of input rotational power T1 or output rotational power T2 from a first a rotational speed to a second rotational speed. The second speed may be one of greater than or less than the first speed. In some examples, speed changer 211 comprises a plurality of gears (e.g., a gearbox, a harmonic drive, or another plurality of gears and/or splines) configured to convert output torque TO from the first rotational speed to the second rotational speed.

In some examples, output pathway 154 includes a coupling system 213 configured to transfer mechanical power MP from clutching mechanism 150 (e.g., clutching output shaft 192) to compressor 120 (e.g., compressor input shaft 143). Coupling system 213 may be configured to transfer mechanical power MP such that compressor 120 receives the mechanical power MP as rotary input torque TI and/or linear input force FI. In examples, coupling system 213 includes one or more components such as shafts, linkages, gears, and/or other components configured to transfer mechanical power MP from clutching mechanism 150 to compressor 120. In examples, coupling system 213 is configured to substantially transfer input torque TI and/or linear input force FI from clutching output shaft 192 to compressor input shaft 143.

In examples, system 100 is configured to cause turbine assembly 144 to deploy when electrical power EP falls below the threshold, such that turbine assembly 144 may generate mechanical power MP and provide the mechanical power MP to compressor 120. For example, turbine assembly 144 may be configured to establish a deployed configuration (as depicted in solid lines in FIG. 2) and a stowed configuration (as depicted in dashed lines in FIG. 2). Turbine assembly 144 may be configured such that turbine 146 (e.g., turbine blades 182) receives ran air flow FR in the deployed configuration. Turbine assembly 144 may be configured to limit (e.g., substantially prevent) the receipt of ram air flow FR by turbine 146 (e.g., turbine blades 182) in the stowed configuration. For example, turbine assembly 144 may be configured such that turbine 146 is positioned within a stowage bay 212 in the stowed configuration. Turbine assembly 144 may be configured such that turbine 146 is positioned substantially outside of (e.g., is extended from) stowage bay 212 in the deployed configuration. In examples, turbine assembly 144 is configured to transition from the stowed configuration to the deployed configuration when electrical power EP falls below the threshold.

For example, turbine assembly 144 may include a support system 214 which includes a support member 216. Support member 216 may be configured to support turbine 146. In examples, support member 216 is configured to position in a first position relative to fuselage 104 when turbine assembly 144 is in the deployed configuration, position in a second position relative to fuselage 104 when turbine assembly 144 is in the stowed configuration, and/or transition between the first position and the second position when turbine assembly 144 transitions between the deployed configuration and the stowed configuration.

Hence, system 100 may be configured such that, when electrical distribution system 138 is providing electrical power EP (e.g., to compressor motor 134) at a level greater than or equal to the threshold, turbine assembly 144 retains support member 216 in the second position (e.g., as depicted by dashed lines in FIG. 2), such that the receipt of ram air flow FR by turbine 146 is limited and mechanical power MP provided to compressor 120 is limited (e.g., substantially absent). System 100 may be configured such that, when the electrical power EP falls below the threshold, turbine assembly 144 transitions support member 216 from the second position to the first position (e.g., as depicted by solid lines in FIG. 2), such that the receipt of ram air flow FR by turbine 146 increases and mechanical power MP provided to compressor 120 increases. Thus, system 100 may be configured such that, when electrical power EP falls below the threshold, system 100 causes turbine assembly 144 to transition from the stowed configuration to the deployed configuration, such that turbine assembly 144 may provide mechanical power MP to compressor 120.

In examples, support system 214 is configured to cause support member 216 to move relative to some portion of vehicle 102 when support member 216 transitions between the first position and the second position. For example, support member 216 may be configured to move relative to a bulkhead 218 (e.g., a pressure bulkhead) comprising a portion of and/or supported by fuselage 104 of vehicle 102. Bulkhead 218 may be configured to maintain internal atmosphere EI (FIG. 1) within one or more of compartments 112 greater than or equal to external atmosphere EO substantially external to and/or surrounding vehicle 102 (e.g., when vehicle 102 is in flight).

In some examples, bulkhead 218 is a portion of a boundary 220 substantially defining stowage bay 212. In examples, at least some portion of input pathway 152 (e.g., first input shaft 206 and/or another mechanical component of input pathway 152) is configured to pass through bulkhead 218 to deliver mechanical power MP to clutching mechanism 150. For example, the portion of input pathway 152 may be configured to extend through an access 222 (e.g., defined by bulkhead 218) to pass through bulkhead 218. Bulkhead 218 may be configured to maintain internal atmosphere EI greater than or equal to external atmosphere EO as input pathway 152 passes through bulkhead 218. In some examples, input pathway 152 includes a pressure seal 224 configured to assist in maintaining internal atmosphere EI greater than or equal to external atmosphere EO as the portion of input pathway 152 passes through bulkhead 218. In some examples, pressure seal 224 may be, for example, a fairlead, a stuffing tube, a packing, or some other type of pressure seal.

Turbine assembly 144 may include an positioning system 226 configured to cause turbine assembly 144 to substantially maintain the stowed configuration, maintain the deployed configuration, and/or transition between the stowed configuration and the deployed configuration. In examples, positioning system 226 is configured to turbine assembly 144 to substantially maintain the stowed configuration, maintain the deployed configuration, and/or transition between the stowed configuration and the deployed configuration based on the electrical power EP provided by electrical distribution system 138 (e.g., provided to compressor motor 134).

For example, positioning system 226 may be configured to sense electrical power EP provided by electrical distribution system 138. Positioning system 226 may be configured to establish a first system state (e.g., an energized state) when electrical distribution system 138 senses electrical power EP is greater than or equal to the threshold, and establish a second system state (e.g., a deenergized state) when electrical power EP is below the threshold. Positioning system 226 may be configured to cause turbine assembly 144 to substantially maintain one of the stowed configuration or the deployed configuration in the first system state, cause turbine assembly 144 to substantially maintain the other of the stowed configuration or the deployed configuration in the second system state, and cause turbine assembly 144 to transition between the stowed configuration engaged configuration and the disengaged configuration when positioning system 226 transitions between the first system state and the second system state.

For example, positioning system 226 may include a pneumatic and/or hydraulic system configured to cause turbine assembly 144 to at least one of substantially maintain the stowed configuration, substantially maintain the deployed configuration, and/or transition between the stowed configuration and the deployed configuration using a fluid pressure in the pneumatic and/or hydraulic system. Positioning system 226 may be configured to alter the fluid pressure based on electrical power EP provided by electrical distribution system 138 (e.g., to compressor motor 134). Positioning system 226 may include one or components (e.g., one or more valves) configured to alter their position (e.g., to open or close) when positioning system 226 transitions between the first system state and the second system state. Positioning system 226 may be configured such that altering the position of the component alters the fluid pressure in the pneumatic and/or hydraulic system, and causes turbine assembly 144 to transition between the stowage configuration and the deployed configuration.

In some examples, positioning system 226 includes one or electrical and or electronic components (e.g., one or more switches or relays) configured to provide and/or interrupt a delivery of electrical power to positioning system 226 based on electrical power EP provided by electrical distribution system 138. The electrical and/or electronic components may be configured to alter their position (e.g., transition between an open position or a closed position) when positioning system 226 transitions between the first system state and the second system state. Transfer system 202 may be configured such that altering the position of the electrical and/or electronic components causes turbine assembly 144 to transition between the stowage configuration and the deployed configuration.

In some examples, control system 170 is configured to cause positioning system 226 to maintain the first system state, maintain the second system state, and/or transition between the first system state and the second system state. For example, control system 170 may be configured to cause positioning system 226 to establish the first system state when control system 170 senses (e.g., using cables 205) that electrical power EP is greater than or equal to the threshold. Control system 170 may be configured to cause positioning system 226 to establish the second system state when control system 170 senses (e.g., using cables 205) that electrical power EP is below the threshold. In examples, control system 170 is configured to send a signal (e.g., via a communication link 209) to positioning system 226 to cause positioning system 226 to maintain the first system state, maintain the second system state, and/or transition between the first system state and the second system state. Positioning system 226 may include positioning system control circuitry (not shown) configured to cause positioning system 226 to maintain the first system state, maintain the second system state, and/or transition between the first system state and the second system state based on the signal (or lack thereof) to positioning system 226.

In some examples, system 100 includes a user input device 228 (e.g., a switch, button, touchscreen, or the like) operable by, for example, a flight crew member or maintenance member and configured to cause clutching mechanism 150 to transition between the disengaged configuration and the engaged configuration and/or cause turbine assembly 144 to transition between the stowage configuration and the deployed configuration. User input device 228 may be configured such that a user can provide input to one or more of control system 170, clutching mechanism 150, and/or turbine assembly 144. In response to receiving the user input (e.g., via a communication link 230), control system 170 may be configured to cause clutching mechanism 150 to transition between the disengaged configuration and the engaged configuration and/or cause turbine assembly 144 to transition between the stowage configuration and the deployed configuration. In response to receiving the user input (e.g., via a communication link 232), clutching mechanism 150 may be configured to transition between the disengaged configuration and the engaged configuration. In response to receiving the user input (e.g., via a communication link 234), turbine assembly 144 (e.g., positioning system 226) may be configured to cause turbine assembly 144 to transition between the stowage configuration and the deployed configuration.

Control system 170, control circuitry 188, and/or other control circuitry of system 100 may include fixed function circuitry and/or programmable operating circuitry. In examples, control system 170, control circuitry 188, and/or other control circuitry of system 100 includes circuitry configured to perform one or more functions of operating circuitry, such as sensing circuitry, processing circuitry, switching circuitry, communication circuitry, and/or other circuitries. Control system 170, control circuitry 188, and/or other control circuitry of system 100, as well as other processors, operating circuitry, controllers, control circuitry, processing circuitry, and the like, described herein, may include any combination of integrated circuitry, discrete logic circuity, analog circuitry, such as one or more microprocessors, digital signal processors (DSPs), application specific integrated circuits (ASICs), or field-programmable gate arrays (FPGAs). In some examples, control system 170 includes multiple components, such as any combination of one or more microprocessors, one or more DSPs, one or more ASICs, or one or more FPGAs, as well as other discrete or integrated logic circuitry, and/or analog circuitry.

Functions attributed to control system 170, control circuitry 188, and/or other control circuitry of system 100 may be embodied as software, firmware, hardware or any combination thereof. Control system 170, control circuitry 188, and/or other control circuitry of system 100 may include, for instance, a variety of capacitors, transformers, switches, and the like configured to perform the functions of control system 170, control circuitry 188, and/or other control circuitry of system 100. In examples, control system 170, control circuitry 188, and/or other control circuitry of system 100 may be configured to communicate with another device of system 100 and/or vehicle 102, such as electrical distribution system 138, clutching mechanism 150, turbine assembly 144, compressor 120, and/or components of system 100 and/or vehicle 102. Control system 170, control circuitry 188, and/or other control circuitry of system 100 may include any suitable hardware, firmware, software or any combination thereof for communicating with another device. In addition, control system 170, control circuitry 188, and/or other control circuitry of system 100 may communicate with a networked computing device and a computer network.

System 100 (e.g., control system 170, control circuitry 188, and/or other control circuitry of system 100) can also include memory configured to store program instructions, such as software, which may include one or more program modules, which are executable by control system 170, control circuitry 188, and/or other control circuitry of system 100. The program instructions may be embodied in software and/or firmware. The memory can include any volatile, non-volatile, magnetic, optical, or electrical media, such as a random access memory (RAM), read-only memory (ROM), non-volatile RAM (NVRAM), electrically-erasable programmable ROM (EEPROM), ferroelectric RAM (FRAM), flash memory, or any other digital media. In some examples, the memory includes computer-readable instructions that, when executed by control system 170 cause control system 170, control circuitry 188, and/or other control circuitry of system 100 to perform various functions described herein and/or other functions of control system 170, control circuitry 188, and/or other control circuitry of system 100.

User input device 228 may have any suitable configuration. For example, user input device 228 can include a switch (e.g., a mechanical switch), a button or keypad, a speaker configured to receive voice commands from a user, a display, such as a liquid crystal (LCD), light-emitting diode (LED), or organic light-emitting diode (OLED). In some examples, user input device 228 may include a touch screen. User input device 228 may be configured to receive a user input. In some examples, user input device 228 is also configured to display information, such as one or more indications providing information on the actuation of system 100 (e.g., clutching mechanism 150 and/or turbine assembly 144).

Communication links 207, 209, 230, 232, 234 may be hard-line and/or wireless communications links. In some examples, communication links 207, 209, 230, 232, 234 may comprise some portion of control system 170. In some examples, communication links 207, 209, 230, 232, 234 comprise a wired connection, a wireless Internet connection, a direct wireless connection such as wireless LAN, Bluetooth™, Wi-Fi™, and/or an infrared connection. Communication links 207, 209, 230, 232, 234 may utilize any wireless or remote communication protocol.

As used here, when a first portion of a system (e.g., system 100) is substantially parallel to a second portion of or an axis defined by the system, this may mean the first portion is parallel or nearly parallel to the second portion or the axis to the extent permitted by manufacturing tolerances. In some examples, when the first portion is substantially parallel to the second portion or the axis, this may mean a first vector defined by the first component of the system defines an angle of less than 10 degrees, in some examples less than 5 degrees, and in some examples less than 1 degree, with a second vector defined by the second component or the axis.

As used here, when a first portion of a system (e.g., system 100) supports a second portion of the system, this means that when the second portion causes a first force to be exerted on the first portion, the first portion causes a second force to be exerted on the second portion in response to the first force. The first force and/or second force may be a contact force and/or an action-at-a-distance force. For example, first force and/or second force may be mechanical force, a magnetic force, a gravitational force, or some other type of force. The first portion of the system may be a portion of the system or a portion of a component of the system. The second portion of the system may be another portion of the system or another portion of the same component or a different component. In some examples, when the first portion of the system supports the second portion of the system, this may mean the second portion is mechanically supported by and/or mechanically connected to the first portion.

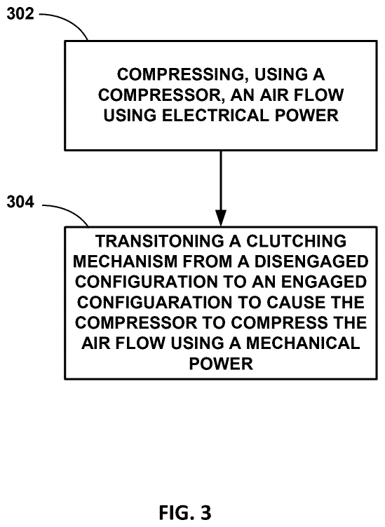

FIG. 3 is a flow diagram illustrating an example technique for providing a compressed air flow FC to compartments 112 of a vehicle 102. While the technique is described with reference to system 100 described herein, the technique may be used with other components and/or systems in other examples.

The technique includes compressing, by a compressor 120 using an electrical power EP from an electrical distribution system 138 of a vehicle 102, an inlet air flow FO, wherein compressor 120 is configured to compress inlet air flow FO using at least one of the electrical power EP or a mechanical power MP produced by a turbine assembly 144 (302). In examples, a compressor motor 134 receives the electrical power EP from electrical distribution system 138. Compressor motor 134 may produce at least one of a torque T or an axial force F using the electrical power EP and transfer the at least one of the torque T or the axial force F to a compressing element 130 of compressor 120.

The technique includes causing, when the electrical power EP decreases below a threshold, compressor 120 to compress inlet air flow FI using the mechanical power MP (304). A clutching mechanism 150 may transition from a disengaged configuration to an engaged configuration to cause compressor 120 to compress inlet air flow FI using the mechanical power MP. In examples, clutching mechanism 150 limits the delivery of the mechanical power MP from turbine assembly 144 to compressor 120 in the disengaged configuration and increases the delivery of the mechanical power MP from turbine assembly 144 to compressor 120 in the engaged configuration. In examples, clutching mechanism 150 transitions from the disengaged configuration to the engaged configuration when the electrical power EP decreases below the threshold.

In examples, a turbine 146 of turbine assembly 144 generates the mechanical power MP. Turbine 146 may generate the mechanical power MP when turbine 146 receives a ram air flow FR. In examples, turbine 146 generates the mechanical power MP when ram air flow FR impacts turbine blades 182. In some examples, turbine assembly 144 allows the receipt of ram air flow FR by turbine blades 182 in a deployed configuration and limits the receipt of ran air flow FR by turbine blades 182 in a stowed configuration. In examples, a positioning system 226 causes turbine assembly 144 to transition from the stowed configuration to the deployed configuration when the electrical power EP decreases below the threshold.

The technique may include providing a compressed air flow FC comprising inlet air flow FO to one or more of compartments 112 of vehicle 102. In examples, inlet air flow FO has a pressure lower than a pressure of compressed air flow FC. In examples, inlet air flow FO has a pressure substantially equal to a pressure of an external environment EO surrounding vehicle 102. Compressor 120 may provide compressed air flow to compartments 112 to substantially maintain a pressure of an internal environment EI within compartments 112 greater than the pressure of external environment EO. In some examples, the technique includes controlling the pressure of internal environment EI using an outflow valve 178.

In some examples, compressor 120 compresses inlet air flow FO and provides a first flow F1 comprising at least a portion of inlet air flow FO. A heat exchanger 156 may cool first flow F1 to provide compressed flow FC. In examples, heat exchanger 156 cools first flow F1 by causing a heat exchange between first flow F1 and a cooling flow F2. In some examples, compressor housing 131 provides cooling flow F2 to heat exchanger 156. Heat exchanger 156 may provide the thus cooled first flow F1 as compressed air flow FC (e.g., to a supply conduit 158).

The disclosure includes the following examples.

Example 1: A system comprising: a turbine assembly configured to couple to a vehicle body of a vehicle, the turbine assembly including a turbine configured to produce a mechanical power when the turbine receives a ram air flow; a compressor configured to receive an inlet air flow, wherein the compressor is configured to compress the inlet air flow using a compressor power to provide a compressed air flow, wherein the compressor power includes at least one of an electrical power provided by an electrical distribution system of the vehicle or the mechanical power produced by the turbine; and a clutching mechanism having an engaged configuration and a disengaged configuration, wherein the clutching mechanism is configured to limit a delivery of the mechanical power from the turbine assembly to the compressor in the disengaged configuration and increase the delivery of the mechanical power from the turbine assembly to the compressor in the engaged configuration, and wherein the clutching mechanism is configured to transition from the disengaged configuration to the engaged configuration when the electrical power provided by the electrical distribution system decreases below a threshold.

Example 2: The system of example 1, further comprising a control system configured to monitor the electrical power received by the compressor and cause, in response to the electrical power provided by the electrical distribution system decreasing below the threshold, the clutching mechanism to transition from the disengaged configuration to the engaged configuration.

Example 3: The system of example 1 or example 2, wherein the turbine assembly is configured to establish a deployed configuration and a stowed configuration, wherein the turbine is configured to receive the ram air flow when the turbine assembly is in the deployed configuration, and wherein the turbine assembly is configured to limit a receipt of the ram air flow by the turbine in the stowed configuration.

Example 4: The system of example 3, wherein the turbine assembly is configured to transition from the stowed configuration to the deployed configuration when the electrical power provided by the electrical distribution system decreases below the threshold.

Example 5: The system of example 4, wherein the turbine assembly includes a support member coupled to the turbine, wherein: the support member is configured to position in a first position relative to the vehicle body and configured to position in a second position relative to the vehicle body, the support member is configured to place the turbine assembly in the stowed configuration when the support member is in the second position and configured to place the turbine assembly in the deployed configuration when the support member is in the first position, and the support member is configured to transition from the second position to the first position when the electrical power provided by the electrical distribution system decreases below the threshold.

Example 6: The system of any of examples 1-5, further comprising a heat exchanger, wherein the compressor is configured to compress a first portion of the inlet air flow to provide the compressed flow and provide a second portion of the inlet air flow to the heat exchanger, wherein the heat exchanger is configured to receive the compressed flow from the compressor and cause a heat transfer from the compressed flow to the second portion to produce a cooled compressed flow, and wherein the heat exchanger is configured to provide the cooled compressed flow to a compartment of the vehicle.

Example 7: The system of any of examples 1-6, wherein the compressor includes a motor configured to receive the electrical power from the electrical distribution system, wherein the motor is configured to impart at least one of a torque or an axial force to a compressing element of the compressor when the motor receives the electrical power provided by the electrical distribution system, and wherein the compressor is configured to compress the inlet air flow using the compressing element when the motor imparts the at least one of the torque or the axial force.

Example 8: The system of example 7, wherein the motor is configured to impart the at least one of the torque or the axial force to the compressing element using a first compressor shaft of the compressor, and wherein compressor is configured to receive the mechanical power using a second compressor shaft of the compressor, wherein the first compressor shaft and the second compressor shaft are configured to cause the compressing element to compress the inlet air flow.

Example 9: The system of any of examples 1-8, wherein the clutching mechanism is configured to deliver the mechanical power to a compressing element of the compressor when the clutching mechanism is in the engaged configuration, and wherein the compressing element is configured to compress the inlet air flow using the mechanical power.

Example 10: The system of any of examples 1-9, wherein the turbine is a ram air turbine including a plurality of blades coupled to a shaft, wherein the turbine is configured to cause the ram air to impact the plurality of blades when the turbine receives the ram air, and wherein the plurality of blades are configured to cause rotation of the shaft when the ram air impacts the plurality of blades.

Example 11: The system of any of examples 1-10, further comprising a gear assembly, wherein the gear assembly is configured to receive the mechanical power from the turbine assembly as an input rotational power acting around a first axis, wherein the gear assembly is configured to transfer the mechanical power to the clutching mechanism as an output rotational power acting around a second axis, and wherein the second axis is angularly displaced from the first axis.

Example 12: The system of example 11, wherein the gear assembly includes a bevel gear assembly configured to receive at least a portion of the input rotational power around the first axis and provide at least a portion of the output rotational power around the second axis.

Example 13: The system of any of examples 1-12, further comprising the vehicle body, wherein the vehicle body supports at least the turbine assembly, the compressor, and the clutching mechanism.

Example 14: The system of any of examples 1-13, wherein the compressor is configured to provide the compressed air flow to a compartment supported by the vehicle.

Example 15: The system of any of examples 1-14, further comprising: a control system configured to monitor a pressure in a compartment supported by the vehicle; and an outflow valve configured to issue a discharge air flow comprising the compressed air flow from the compartment to an external environment surrounding the vehicle body, wherein the control system is configured to control a position of the outflow valve based on the pressure in the compartment.

Example 16: A system comprising: a turbine assembly including a turbine, the turbine assembly configured to establish a deployed configuration relative to an aircraft body of an aircraft and establish a stowed configuration relative to the aircraft body, wherein the turbine is configured to receive a ram air flow and produce a mechanical power using the ram air flow when the turbine assembly is in the deployed configuration, and wherein the turbine assembly is configured to limit a receipt of the ram air flow by the turbine when the turbine assembly is in the stowed configuration; a compressor configured to receive an air flow, wherein the compressor is configured to compress the air flow to provide a compressed air flow using a compressor power, wherein the compressor is configured to produce the compressor power using at least one of an electrical power provided by an electrical distribution system of the aircraft or the mechanical power produced by the turbine; and a clutching mechanism having an engaged configuration and a disengaged configuration, wherein the clutching mechanism is configured to limit a delivery of the mechanical power from the turbine to the compressor in the disengaged configuration and increase the delivery of the mechanical power from the turbine to the compressor in the engaged configuration, wherein the clutching mechanism is configured to transition from the disengaged configuration to the engaged configuration when the electrical power provided by the electrical distribution system decreases below a threshold, wherein the turbine assembly is configured to transition from the stowed configuration to the deployed configuration when the electrical power provided by the electrical distribution system decreases below the threshold, and wherein the system is configured to provide the compressed air flow to a compartment supported by the aircraft.

Example 17: The system of example 16, further comprising a heat exchanger, wherein the compressor is configured to compress a first portion of the air flow to provide the compressed flow and provide a second portion of the air flow to the heat exchanger, wherein the heat exchanger is configured to receive the compressed flow from the compressor and cause a heat transfer from the compressed flow to the second portion to produce a cooled compressed flow, and wherein the heat exchanger is configured to provide the cooled compressed flow to the compartment.

Example 18: The system of example 16 or example 17, further comprising: a control system configured to monitor a pressure in the compartment; and an outflow valve configured to issue a discharge air flow comprising the compressed air flow from the compartment to an external environment surrounding the aircraft body, wherein the control system is configured to control a position of the outflow valve based on the pressure in the compartment.

Example 19: A method, comprising: compressing, by a compressor using electrical power from an electrical distribution system of an aircraft, an inlet air flow, wherein the compressor is configured to compress the inlet air flow using at least one of the electrical power or a mechanical power produced by a turbine assembly; and causing, when the electrical power decreases below a threshold, and by transitioning a clutching mechanism from a disengaged configuration to an engaged configuration, the compressor to compress the inlet air flow using the mechanical power, wherein the clutching mechanism is configured to limit a delivery of the mechanical power from the turbine assembly to the compressor in the disengaged configuration and increase the delivery of the mechanical power from the turbine assembly to the compressor in the engaged configuration.

Example 20: The method of example 19, further comprising causing, using the system, the turbine assembly to transition from a stowed configuration to a deployed configuration when the electrical power provided by the electrical distribution system decreases below the threshold, wherein a turbine is configured to receive a ram air flow and produce the mechanical power using the ram air flow when the turbine assembly is in the deployed configuration, and wherein the turbine assembly is configured to limit a receipt of the ram air flow by the turbine when the turbine assembly is in the stowed configuration.

Various examples have been described. These and other examples are within the scope of the following claims.

What is claimed is:

1. A system comprising:
a turbine assembly configured to couple to a vehicle body of a vehicle, the turbine assembly including a turbine configured to produce a mechanical power when the turbine receives a ram air flow;
a compressor configured to receive an inlet air flow, wherein the compressor is configured to compress the inlet air flow using a compressor power to provide a compressed air flow, wherein the compressor power includes at least one of an electrical power provided by an electrical distribution system of the vehicle or the mechanical power produced by the turbine; and
a clutching mechanism having an engaged configuration and a disengaged configuration,
wherein the clutching mechanism is configured to limit a delivery of the mechanical power from the turbine assembly to the compressor in the disengaged configuration and increase the delivery of the mechanical power from the turbine assembly to the compressor in the engaged configuration, and
wherein the clutching mechanism is configured to transition from the disengaged configuration to the engaged configuration when the electrical power provided by the electrical distribution system decreases below a threshold.

2. The system of claim 1, further comprising a control system configured to monitor the electrical power received by the compressor and cause, in response to the electrical power provided by the electrical distribution system decreasing below the threshold, the clutching mechanism to transition from the disengaged configuration to the engaged configuration.

3. The system of claim 1, wherein the turbine assembly is configured to establish a deployed configuration and a stowed configuration, wherein the turbine is configured to receive the ram air flow when the turbine assembly is in the deployed configuration, and wherein the turbine assembly is configured to limit a receipt of the ram air flow by the turbine in the stowed configuration.

4. The system of claim 3, wherein the turbine assembly is configured to transition from the stowed configuration to the deployed configuration when the electrical power provided by the electrical distribution system decreases below the threshold.

5. The system of claim 4, wherein the turbine assembly includes a support member coupled to the turbine, wherein:
the support member is configured to position in a first position relative to the vehicle body and configured to position in a second position relative to the vehicle body,
the support member is configured to place the turbine assembly in the stowed configuration when the support member is in the second position and configured to place the turbine assembly in the deployed configuration when the support member is in the first position, and
the support member is configured to transition from the second position to the first position when the electrical power provided by the electrical distribution system decreases below the threshold.

6. The system of claim 1, further comprising a heat exchanger,
wherein the compressor is configured to compress a first portion of the inlet air flow to provide the compressed flow and provide a second portion of the inlet air flow to the heat exchanger,
wherein the heat exchanger is configured to receive the compressed flow from the compressor and cause a heat transfer from the compressed flow to the second portion to produce a cooled compressed flow, and
wherein the heat exchanger is configured to provide the cooled compressed flow to a compartment of the vehicle.

7. The system of claim 1,
wherein the compressor includes a motor configured to receive the electrical power from the electrical distribution system,
wherein the motor is configured to impart at least one of a torque or an axial force to a compressing element of the compressor when the motor receives the electrical power provided by the electrical distribution system, and
wherein the compressor is configured to compress the inlet air flow using the compressing element when the motor imparts the at least one of the torque or the axial force.

8. The system of claim 7, wherein the motor is configured to impart the at least one of the torque or the axial force to the compressing element using a first compressor shaft of the compressor, and wherein compressor is configured to receive the mechanical power using a second compressor shaft of the compressor, wherein the first compressor shaft and the second compressor shaft are configured to cause the compressing element to compress the inlet air flow.

9. The system of any of claim 1, wherein the clutching mechanism is configured to deliver the mechanical power to a compressing element of the compressor when the clutching mechanism is in the engaged configuration, and wherein the compressing element is configured to compress the inlet air flow using the mechanical power.

10. The system of claim 1, wherein the turbine is a ram air turbine including a plurality of blades coupled to a shaft, wherein the turbine is configured to cause the ram air to impact the plurality of blades when the turbine receives the ram air, and wherein the plurality of blades are configured to cause rotation of the shaft when the ram air impacts the plurality of blades.

11. The system of claim 1, further comprising a gear assembly,
wherein the gear assembly is configured to receive the mechanical power from the turbine assembly as an input rotational power acting around a first axis,
wherein the gear assembly is configured to transfer the mechanical power to the clutching mechanism as an output rotational power acting around a second axis, and
wherein the second axis is angularly displaced from the first axis.

12. The system of claim 11, wherein the gear assembly includes a bevel gear assembly configured to receive at least a portion of the input rotational power around the first axis and provide at least a portion of the output rotational power around the second axis.

13. The system of claim 1, further comprising the vehicle body, wherein the vehicle body supports at least the turbine assembly, the compressor, and the clutching mechanism.

14. The system of claim 1, wherein the compressor is configured to provide the compressed air flow to a compartment supported by the vehicle.

15. The system of claim 1, further comprising:
a control system configured to monitor a pressure in a compartment supported by the vehicle; and
an outflow valve configured to issue a discharge air flow comprising the compressed air flow from the compartment to an external environment surrounding the vehicle body,
wherein the control system is configured to control a position of the outflow valve based on the pressure in the compartment.

16. A system comprising:
a turbine assembly including a turbine, the turbine assembly configured to establish a deployed configuration relative to an aircraft body of an aircraft and establish a stowed configuration relative to the aircraft body,
wherein the turbine is configured to receive a ram air flow and produce a mechanical power using the ram air flow when the turbine assembly is in the deployed configuration, and
wherein the turbine assembly is configured to limit a receipt of the ram air flow by the turbine when the turbine assembly is in the stowed configuration;
a compressor configured to receive an air flow, wherein the compressor is configured to compress the air flow to provide a compressed air flow using a compressor power, wherein the compressor is configured to produce the compressor power using at least one of an electrical power provided by an electrical distribution system of the aircraft or the mechanical power produced by the turbine; and
a clutching mechanism having an engaged configuration and a disengaged configuration,
wherein the clutching mechanism is configured to limit a delivery of the mechanical power from the turbine to the compressor in the disengaged configuration and increase the delivery of the mechanical power from the turbine to the compressor in the engaged configuration,
wherein the clutching mechanism is configured to transition from the disengaged configuration to the engaged configuration when the electrical power provided by the electrical distribution system decreases below a threshold,
wherein the turbine assembly is configured to transition from the stowed configuration to the deployed configuration when the electrical power provided by the electrical distribution system decreases below the threshold, and
wherein the system is configured to provide the compressed air flow to a compartment supported by the aircraft.

17. The system of claim 16, further comprising a heat exchanger,
wherein the compressor is configured to compress a first portion of the air flow to provide the compressed flow and provide a second portion of the air flow to the heat exchanger,
wherein the heat exchanger is configured to receive the compressed flow from the compressor and cause a heat transfer from the compressed flow to the second portion to produce a cooled compressed flow, and
wherein the heat exchanger is configured to provide the cooled compressed flow to the compartment.

18. The system of claim 16, further comprising:
a control system configured to monitor a pressure in the compartment; and
an outflow valve configured to issue a discharge air flow comprising the compressed air flow from the compartment to an external environment surrounding the aircraft body,
wherein the control system is configured to control a position of the outflow valve based on the pressure in the compartment.

19. A method, comprising:
compressing, by a compressor using electrical power from an electrical distribution system of an aircraft, an inlet air flow, wherein the compressor is configured to compress the inlet air flow using at least one of the electrical power or a mechanical power produced by a turbine assembly; and
causing, when the electrical power decreases below a threshold, and by transitioning a clutching mechanism from a disengaged configuration to an engaged configuration, the compressor to compress the inlet air flow using the mechanical power,
wherein the clutching mechanism is configured to limit a delivery of the mechanical power from the turbine assembly to the compressor in the disengaged configuration and increase the delivery of the mechanical power from the turbine assembly to the compressor in the engaged configuration.

20. The method of claim 19, further comprising causing, using the system, the turbine assembly to transition from a stowed configuration to a deployed configuration when the electrical power provided by the electrical distribution system decreases below the threshold, wherein a turbine is configured to receive a ram air flow and produce the mechanical power using the ram air flow when the turbine assembly is in the deployed configuration, and wherein the turbine assembly is configured to limit a receipt of the ram air flow by the turbine when the turbine assembly is in the stowed configuration.
